(19) United States
(12) Patent Application Publication
(10) Pub. No.: US 2013/0089660 A1
(43) Pub. Date: Apr. 11, 2013

(54) METHOD FOR MANUFACTURING A COMPOSITE POWDER THAT CAN BE USED TO CONSTITUTE ELECTRODE MATERIALS

(71) Applicants: Sophie Beaudet Savignat, Ballan-Mire (FR); Thierry Chartier, Feytat (FR); Benedicte Chastagnier, Saint Paul (FR); Claire Bonhomme, Limoges (FR)

(72) Inventors: Sophie Beaudet Savignat, Ballan-Mire (FR); Thierry Chartier, Feytat (FR); Benedicte Chastagnier, Saint Paul (FR); Claire Bonhomme, Limoges (FR)

(73) Assignee: CENTRE NATIONAL DE LA RECHERCHE SCIENTIFIQUE, Paris (FR)

(21) Appl. No.: 13/642,307

(22) PCT Filed: Apr. 20, 2011
(86) PCT No.: PCT/EP11/56311

§ 371 Date: Dec. 19, 2012

(30) Foreign Application Priority Data
Apr. 22, 2010 (FR) 1053071

(51) Int. Cl. H01M 4/38

(52) U.S. Cl. CPC H01M 4/38
USPC 427/126.1

(57) ABSTRACT

The invention relates to a method for preparing a composite powder comprising a core, comprising an apatite and a coating layer covering all or part of said core, which coating layer comprises particles in a metal element and/or in an oxide thereof, which method successively comprises the following steps:
a) a step for putting a suspension of an apatite powder in a liquid medium in contact with a salt of a metal element, which is an acetate of a metal element;
b) a step for evaporating the solvant making up the liquid medium; and
c) a step for calcination of the powder resulting from step b) in an oxidizing atmosphere, by means of which a composite powder is obtained, comprising an apatite core and a coating layer comprising particles of metal oxide; and
d) optionally a step for total or partial reduction of said oxide metal particles into metal particles.

The use of this composite powder for forming an electrode material.

### TECHNICAL FIELD

The present invention relates to a method for making a composite powder which may be used, after shaping, as an electrode material for a fuel cell, in particular a fuel cell of the solid oxide type (subsequently called a <<Solid Oxide Fuel Cell>>).

The general field of the invention is therefore that of solid oxide fuel cells and electrode materials used in these cells.

### STATE OF THE PRIOR ART

A solid oxide cell (or SOFC cell) is an electric generator operating on the following principle: oxygen is reduced at the cathode into O²⁻ ions, which diffuse at high temperature (i.e. a temperature which may range up to 1,000° C.) through a ceramic electrolyte conducting O²⁻ ions and electron-insulating in the direction of the anode where it reacts with the fuel for oxidizing it, forming water and possibly carbon dioxide in the case of a reaction with a hydrocarbon. This oxidation also produces electrons, which will circulate via the external circuit towards the cathode.

The reaction at the cathode is the following:

O₂+4e⁻←2O²⁻

The reaction which may be contemplated at the anode is the following:

H₂₊O²⁻←H₂O+2e⁻

The electrodes (cathode and anode) of this type of cell are made up on the basis of porous ceramic materials separated by a dense electrolyte, for example in zirconia stabilized by yttrium oxide (symbolized by the acronym YSZ).

The cathode is generally based on a doped lanthanum manganite while the anode is conventionally based on a cermet (i.e. a ceramic-metal composite). Presently, the cermet used for forming the anode is often a cermet comprising nickel dispersed in an YSZ ceramic matrix.

The high operating temperatures of these SOFC fuel cells pose many problems, notably from the fact that they generate early aging of the ceramic materials.

In order to solve this early aging problem, the idea of certain authors was to decrease the operating temperature of the cell, for example in ranges of temperatures not exceeding 800° C. However, in these ranges of temperatures, the conductivity of the YSZ electrolyte is significantly reduced, causing an increase in ohmic voltage drops and overvoltages as well as slowing down of the kinetics of the electrochemical reactions. In order to be able to thereby efficiently operate these cells in such ranges of temperatures, research turned towards developing novel materials of electrolyte and associated electrodes.

Among the novel electrolyte materials investigated as a replacement for the YSZ material, certain authors propose other materials, such as lanthanum silicate apatites (as described in Solid State Ionics, 2007, 178, 23-24, p. 1337-1343) of formula La₁₀₋ₓAₓ(Si_{1-y}B_{y}O₄)₆O_{2±δ} wherein A is an alkaline or earth alkaline cation, B is a cation selected from Ge⁴⁺, Al³⁺, Mg²⁺, Ga³⁺, B³⁺, Zn²⁺, Nb³⁺/Nb⁵⁺, x is comprised between 0 and 2, y is comprised between 0 and 1, δ is comprised between 0 and 1, which, on the one hand, have ion conductivity greater than or equal to 10⁻² S/cm at 700° C. over a large range of oxygen partial pressures and, are very stable chemically subject to these ranges of temperatures and under both an oxidizing and reducing atmosphere, on the other hand.

Under operating conditions of the cell, the use of these electrolyte materials of the apatite type require the development of electromaterials having satisfactory electrochemical properties at 700° C. and being also compatible with the apatite electrolyte.

The anode material of the Ni/YSZ cermet type has good electrochemical performances in the presence of hydrogen. However, this material cannot be associated with an electrolyte of the lanthanum apatite type, as defined above because of the reaction which occurs between the apatite and YSZ. Indeed, the formation of a fuel cell from cermet and apatite is accomplished by sintering at high temperatures (for example, 1,400° C. for 2 hours), which is accompanied by the formation of an insulating phase of formula La₂Zr₂O₇, which is highly detrimental to proper operation of the SOFC cell. Further, after an aging heat treatment for 1 week at 800° C., the occurrence of this insulating phase was also ascertained.

Therefore, in order to be able to develop SOFC cells from a lanthanum apatite electrolyte as defined above, novel anode materials should be developed instead and in place of Ni/YSZ cermets which are conventionally used.

One of the contemplated solutions is to use an Ni/apatite cermet for forming the anode material.

Conventionally, such a cermet is made by a method comprising the following steps:

a step for mixing an apatite powder and a nickel oxide powder;

a step for shaping said mixture of powders into the form of a film;

a step for sintering the film in air;

a step for reduction so as to transform the nickel oxide into nickel metal, this reduction step may be carried out upon starting the cell which operates with hydrogen.

However, the performances of Ni-apatite cermet during the operation of the cell under H₂ degrade over time mainly because the enlargement of the nickel Ni particles resulting from the agglomeration thereof, leading to the reduction of the triple points in the material and to the suppression of electron percolation paths.

Another way for making such a cermet consisted of impregnating a porous apatite matrix with a nickel precursor solution, such as a nickel nitrate solution.

However, with this embodiment, a degradation of the electrochemical performances was ascertained at temperatures from 700 to 800° C. also following agglomeration of the nickel.

Furthermore, impregnation of the porous matrix, in order to incorporate an amount of metal phase (for example, of the order of 20% by volume), should be repeated a large number of times (sometimes more than about ten times), which proves to be long and tedious and, in particular difficult to apply on an industrial scale.

Therefore, there exists a real need for a method for making a material based on apatite which may be used as an electrode material, in particular for an anode, at high temperatures without occurrence of an agglomeration phenomenon of the metal element particles which will degrade it and which furthermore may have good electrochemical properties at temperatures of 600-800° C., said method should advantageously preserve the integrity of the apatite (i.e. not cause any degradation of it during its application).

### DISCUSSION OF THE INVENTION

The invention thus relates to a method for preparing a composite powder comprising a core comprising an apatite and a coating layer covering all or part of said core, which coating layer comprising particles in a metal element and/or in an oxide of the latter.

Once it is shaped as a sintered material, highly advantageous properties result from this, notably when this material is intended to form an anode material for an SOFC cell, these properties being the following:

high conductivity of more than 100 S/cm;

good thermomechanical compatibility when the material is associated with an apatite electrolyte material, because of a suitable thermal expansion coefficient;

increased lifetime because the metal phase coating the core in apatite does not agglomerate like in the prior embodiments.

As mentioned above, the constitutive core of the particles forming the powder comprises an apatite, preferably an apatite belonging to the family of lanthanide silicates, such as an apatite fitting the following formula:

A₁₀₋ₓDₓ(MO₄)₆O_{2±δ}

wherein:
A is a lanthanide element;
D is an element selected from alkaline elements, earth alkaline elements and mixtures thereof;
M is an element selected from silicon, germanium, aluminum, magnesium, gallium, boron, zinc, niobium and mixtures thereof;
O is the oxygen element;
x is a number such that 0≦x≦2;
δ is a number such that 0≦δ≦1.

A sub-family falling under the above definition is a family for which A is the lanthanide element and M is a mixture of Si with at least one of the other elements listed above for defining M.

This sub-family may correspond to compounds fitting the following formula:

La₁₀₋ₓDₓ(Si_{1-y}E_{y}O₄)₆O_{2±δ}

wherein:
D fits the same definition as the one explicited above;
E is an element selected from germanium, aluminum, magnesium, gallium, boron, zinc, niobium and mixtures thereof;
x is a number such that 0≦x≦2;
y is a number such that 1≦y≦1;
δ is a number such that 0≦δ≦1.

A particular example of apatite fitting this formula is:

La₉SrSi₆O_{26.5}

The coating layer may comprise particles in a metal element, which may advantageously belong to the group of transition metals.

It is specified that by transition metal is meant a metal having a not completely filled sub-layer d in the state of a neutral atom or in one of their usual oxidation states. These elements are distributed according to three transition series:

the first transition series ranging from scandium to zinc;

the second transition series ranging from yttrium to cadmium;

the third transition series ranging from hafnium to mercury.

In particular, the metal element may be selected from Ru, W, Rh, Ir, Ni, Cu, Pt, Fe, Mo, Pd and mixtures thereof and preferably it may be Ni.

The coating layer may also comprise particles in an oxide of a metal element, the oxides of a metal element may be oxides of transition metals, these metals may be such as those defined above.

In particular, the coating layer may consist of nickel oxide NiO particles.

The constitutive particles of the coating layer may have a nanometric average grain size (i.e. an average grain diameter), for example ranging from 20 to 200 nm.

The metal element and/or an oxide of this element forming a coating around the apatite powder may be present in a content ranging from 25% to 50% by volume, this content being evaluated by the following relationship(V_{metal element and/or oxide thereof})(V_{metal element and/or oxide thereof}+V_{apatite powder}), V corresponding to the volume.

With such a particle size, the result is advantageously an electrode material after shaping of said powder by sintering, having good electrochemical properties in association with an apatite electrolyte in the range of temperatures from 600 to 800° C. because of the increase in the number of gas-O²⁻e⁻ triple points. Furthermore, with such particles, there is no or little agglomeration phenomenon of the latter when the sintered material resulting from these powders is subject to high temperatures.

The aforementioned preparation method successively comprises the following steps:

a) a step for putting a suspension of an apatite powder in a liquid medium into contact with a metal element salt, which salt is a metal element acetate;

b) a step for evaporating the solvant making up the liquid medium; and

c) a step for calcination of the powder resulting from step b) in an oxidizing atmosphere, by means of which a composite powder is obtained, comprising an apatite core and a coating layer comprising particles in metal oxide; and

d) optionally, a step for totally or partly reducing said particles of metal oxide into metal particles.

Thus, step a) consists of putting a suspension of an apatite powder in a liquid medium in contact with a metal element salt, which is a metal element acetate.

It turns out that no metal element oxide powders are used (for example NiO powder, when the metal element is Ni), which is particularly advantageous, since these powders may have safety problems, such as NiO powders, notably for their potential carcinogenicity.

The liquid medium in which the apatite powder is suspended may be an aqueous medium or an organic medium, such as an alcoholic medium.

Preferably, the liquid medium is an aqueous medium such as osmosed water, which has the particularity of facilitating subsequent solubilization of the metal element salt.

First, said suspension may be prepared by putting an apatite powder in contact with a liquid medium under ultrasonic waves, by means of which the powder disperses into said medium.

The apatite powder may have a micrometric average grain size (i.e. an average grain diameter) for example ranging from 0.5 to 5 μm.

This apatite powder may be prepared prior to its being suspended by mixing powders of precursors, via a sole gel route, by co-precipitation or by freeze-drying.

Thus, as an example, when the question is to prepare an apatite powder of formula La₉SrSi₆O_{26.5}, the latter may be prepared by mixing powders of La₂O₃, SiO₂ and SrCO₃, in the required proportions in order to obtain the desired composition, in an attritor in the presence of attrition balls (for example, zirconia balls) and a solvant, such as osmosed water, followed by separation of the formed powder grains from the attrition balls and evaporation of said solvant. The resulting powder is then subject to calcination at an efficient temperature and for an efficient duration in order to obtain formation of the apatite phase. After the calcination step, the powder may be caused to undergo milling (for example by attrition or by another milling technique), so as to obtain a single-mode grain size.

The metal element salt, which is a metal element acetate, may be put into contact with the apatite powder suspension in the form of an aqueous solution of metal element acetate.

The metal element may be a transition metal as defined above.

The authors of the present invention were able to surprisingly ascertain that the use of a metal element acetate instead of and in place of a metal element nitrate (as this is the case in the prior art like in Mater. Res. Soc. Symp. Proc. Vol. 1098, in the article <<Anode Composites Based on NiO and Apatite-Type Lanthanum Silicate for Intermediate Temperature Solid Oxide Fuel Cells>>) gives the possibility of preserving the integrity of the apatite powder, which means that the apatite is not degraded at the level of its composition by reaction with the metal element acetate.

During the contacting step a), a basic solution may be added to the resulting mixture, so as to obtain a mixture having a basic pH, by means of which agglomeration of the apatite particles is avoided.

According to step b), the mixture obtained in step a) undergoes evaporation of the solvant making up the liquid medium, for example by heating with mechanical stirring.

The mixture from this step b) is then calcined in an oxidizing atmosphere at an efficient temperature and for an efficient duration in order to obtain the aforementioned composite powder.

In order to determine the suitable temperature and duration, it may be proceeded with analyses of powders obtained at different temperature and duration pairs by X-ray diffraction in order to determine the optimum temperature and duration for obtaining the desired composite powder.

If the intention is to obtain a composite powder for which the apatite core is covered with a coating layer comprising metal particles, the powder from step c) may be subject to a reduction step which may consist of having a stream comprising a reducing gas pass over said powder.

The powders of the invention obtained according to the method of the invention may be shaped as a sintered material, which may be used as an electrode material.

This material may result from sintering of a composite powder as defined above, this material comprising composite powder agglomerates as defined above.

This material may exist as a film having a thickness which may range from 20 μm to 100 μm (notably, in the case when the material is intended to enter the structure of an anode of a cell with a supporting electrolyte) or may also have a thickness ranging from 100 μm to 3 mm (notably, in the case when the material is intended to enter the structure of an anode of a cell with a supporting anode).

It may be prepared by a method comprising the following steps:

a step for depositing on a substrate said composite powder; and

a step for sintering said thereby deposited powder.

The deposition step may be achieved by screen printing, by pneumatic projection of a suspension of the aforementioned composite powder, by strip-casting a suspension of the aforementioned composite powder, by dip-coating of a suspension of said powder, by spin coating of a suspension of said powder or by ink jet printing.

In particular, the deposition step may be achieved by strip casting of a suspension of said composite powder.

With this technique, it is possible to obtain films in the form of small thickness strips (for example, having a thickness ranging from 25 μm to 2 mm) and with a large surface, if desired, which may be manipulated.

From a practical point of view, this technique consists of displacing on a fixed substrate a mobile shoe leaving a deposit of a layer of a suspension of said powder over its path.

This suspension prepared beforehand may comprise the composite powder as defined above, an organic solvant, a dispersant agent, a binding agent and a plasticizing agent.

As examples of organic solvants, mention may be made of ketone solvants, such as methylethylketone, alcoholic solvants such as ethanol and mixtures thereof (for example, a methylethylketone/ethanol 40%:60% by volume mixture).

As examples of a dispersing agent, mention may be made of a phosphoric ester (such as the ester Beycostat CP 213).

As examples of binding agents, mention may be made of thermoplastic resins, such as methacrylic resins.

As examples of plasticizing agents, mention may be made of phthalate compounds, such as dibutylphthalate (also known under the acronym DBP).

The deposited layer may then be dried before undergoing a sintering step.

The sintering step, regardless of the deposition technique used, consists of heating the layer deposited to an efficient temperature and for an efficient duration so as to obtain cohesion in the form of agglomerates of the powder in the deposited layer.

This sintering step may consist of heating, for example in air, said layer to a temperature ranging from 1,300 to 1,600° C. for a duration ranging from 1 to 3 hours.

If the material was prepared from a composite powder, the coating layer of which comprises particles in metal oxide, the sintering step may be followed by a reduction step consisting of having a stream of reducing gas pass over the material, by means of which the particles in metal oxide are converted into particles in the metal element.

The material may also appear in forms other than those of the film. Thus, the material may also have a tubular shape, notably when it is intended to form an anode in a tubular cell.

In this case, the material may be prepared by a method comprising the following steps:

a step for shaping the aforementioned composite powder in the form of a tube;

a step for sintering said form thereby obtained above.

This shaping step may be achieved by extrusion or isostatic pressing (notably when the material is intended to form an anode in a cell with a supporting anode). It may also be achieved by screen-printing, by pneumatic projection of a suspension of the aforementioned composite powder, by dip-coating of a suspension of said powder, by spin coating of a suspension of said powder or by ink jet printing.

The suspension may meet characteristics identical with those defined for the suspension used for making films.

The sintering step as for it may be achieved under conditions similar to those discussed above for the material appearing as films.

The aforementioned materials, because of their intrinsic properties, have electrically conducting properties and catalytic properties.

So they are particularly suitable for entering the structure of electrode materials, in particular of an anode material, such as for a solid oxide cell like a SOFC cell.

Such an electrode may be intended to be put into contact with an electrolyte in a fuel cell of the SOFC type, in order to form a half-cell of a fuel cell.

Advantageously, the electrolyte comprises a ceramic of the following formula:

A₁₀₋ₓDₓ(MO₄)₆O_{2±δ}

wherein:
A is a lanthanide element;
D is an element selected from alkaline elements, earth alkaline elements and mixtures thereof;
M is an element selected from silicon, germanium, aluminum, magnesium, gallium, boron, zinc, niobium and mixtures thereof, for example a mixture of Si with one of the other elements mentioned above, such as a mixture of Si and Mg, a mixture of Al and Si or a mixture of Si and Ge;
O is the oxygen element;
x is a number such that 0≦x≦2;
δ is a number such that 0≦δ≦1.

An example of such an electrolyte is La₉SrSi₆O_{26.5}.

This type of electrolyte advantageously has:

chemical and thermomechanical compatibility with the anode material, which simplifies the shaping of the half-cell and suppresses the adhesion problems between the anode and the electrolyte, conventionally encountered in the embodiments of the prior art;

large chemical stability in both oxidizing and reducing environments;

efficient diffusion of O²⁻ ions at temperatures ranging from 600 to 800° C. through the presence of conduction channels;

an ion conductivity of at least 10⁻² S.cm⁻¹ at 700° C.;

stability of the conduction properties up to very low oxygen partial pressures (10⁻²⁵ atmosphere).

Half-cells of the invention may be made by a method comprising the following steps:

a step for making a supporting anode by strip-casting, the resulting anode conventionally having a thickness ranging from 200 μm to 1 mm; and

a step for depositing on said anode an electrolyte layer, for example by strip-casting, the electrolyte layer conventionally having a thickness from 10 to 50 μm.

Advantageously, the porosity of the anode is of the order of 30 to 40% by volume.

A half-cell example according to the invention is a half-cell, in which the anode consists of composite powder agglomerates comprising an apatite core of formula La₉SrSi₆O_{26.5} and a coating layer comprising nickel particles and the electrolyte consisting of La₉SrSi₆O_{26.5}.

Cells for a fuel cell, in particular for an SOFC fuel cell, respectively comprise an anode as defined earlier, a cathode and an electrolyte, the electrolyte being positioned between the anode and the cathode.

The electrolyte advantageously meets the same definition as the one given above.

The cathode may comprise a ceramic material with a perovskite structure La₁₋ₓSrₓMn_{1-y}Co_{y}O_{3-δ} with x=0.2, y=0.2 and 0≦δ≦1.

The cathode may also be based on a material of formula A₂MO_{4+δ}, with A representing La, Pr or Nd, M representing Ni or Cu, O is the oxygen element, δ being comprised between 0 and 0.25.

The originality of this type of cathode materials lies in the fact that they have over-stoichiometry in oxygen. These materials also have very interesting catalytic properties at 700° C. towards the reduction of oxygen. Thus, the electron conductivity of nickelates (when M is Ni) may range up to 100 S/cm and ion conductivity may be of the order of 10⁻² to 3*10⁻² S/cm at 700° C., for a cathode operating at 650-750° C.

It may also comprise a doped lanthanum cobaltite of formula La₁₋ₓ₁Srₓ₁Co_{1-y1}Fe_{y1}O_{3±δ1} with x1 comprising between 0.1 and 0.6, y1 comprised between 0.2 and 0.8 and δ1 comprised between 0 and 1 or a doped cobalto-manganite.

The cathode materials, whether these are A₂MO_{4+δ} or cobaltites or cobalto-manganites, have the particularity of operating from 600° C. onwards. Furthermore, they have a chemical, mechanical and electrochemical compatibility with the electrolyte, when the latter is based on apatite as defined above.

A particular cell according to the invention may be a cell, wherein:

the anode comprises a material resulting from the sintering of a composite powder comprising an apatite core of formula La₁₀₋ₓDₓ(Si_{1-y}E_{y}O₄)₆O_{2±δ} as defined above and a coating layer comprising nickel and/or nickel oxide particles, this material comprising the agglomerates of such a composite powder;

the cathode comprises a ceramic material with a perovskite structure La₁₋ₓSrₓMn_{1-y}Co_{y}O_{3-δ} with x=0.2, y=0.2 and 0≦δ≦1; and

the electrolyte comprises a ceramic material of formula A₁₀₋ₓDₓ(MO₄)₆O_{2±δ} as defined above,

said anode and cathode being positioned on either side of the electrolyte.

In particular, the anode may comprise an apatite core comprising an apatite of formula La₉SrSi₆O_{26.5} and a coating layer comprising nickel particles and the electrolyte may comprise a ceramic material of formula La₉SrSi₆O_{26.5}.

The fuel cells of the invention comprising at least one cell according to the invention, may be biased in the opposite direction in order to produce hydrogen from steam, in which case they ensure an electrolyzer function, the anode defined above becoming, because of the change of polarity, an electrolyzer cathode. Thus, the invention also relates to an electrolyzer comprising a cell as defined above, the anode and the cathode becoming the cathode and the anode respectively because of the reverse polarity.

A particularly advantageous fuel cell according to the invention is a fuel cell comprising at least one cell comprising:

an anode comprising a material based on the composite powders of the invention as defined above;

a cathode comprising a ceramic material with a perovskite structure of formula La₁₋ₓSrₓMn_{1-y}Co_{y}O_{3-δ} with x=0.2, y=0.2 and 0≦δ≦1;

an electrolyte comprising a ceramic of formula:

A₁₀₋ₓDₓ(MO₄)₆O_{2±δ}

wherein:
A is a lanthanide element;
D is an element selected from alkaline elements, earth alkaline elements and mixtures thereof;
M is an element selected from silicon, germanium, aluminum, magnesium, gallium, boron, zinc, niobium and mixtures thereof, for example a mixture of Si with one of the other elements mentioned above, such as a mixture of Si and Mg, a mixture of Al and Si or a mixture of Si and Ge;
O is the oxygen element;
x is a number such that 0≦x≦2;
δ is a number such that 0≦δ≦1;
said anode and cathodes being positioned on either side of the electrolyte.

This type of cell has the advantage of only consisting of three ceramic layers, for which two ceramic layers (anode and electrolyte) have compositions such that they make the elaboration method simple to apply, thereby reducing the manufacturing costs. Thus it is not necessary to add intermediate ceramic layers for improving the adhesion of an electrode material onto the electrolytes or for limiting the chemical reactivity between both materials.

Thus, the SOFC cells of the invention operate efficiently at temperatures ranging from 600° C. to 800° C., which generates a reduction in the cost of the system and a slowing down of the ageing of the constitutive elements of the cell.

When the polarity is reversed, and when the cell thus operates like an electrolyzer, the cathode (corresponding to the anode in the SOFC cell) may operate under high steam contents without any risk of oxidation or early ageing as this was observed in the case of a ceramic/metal composite.

The invention will now be described with reference to the following examples given as an illustration and not as a limitation.

### SHORT DESCRIPTION OF THE DRAWINGS

FIG. 1 is a graph illustrating the grain size distribution of the powder obtained according to Example 1a) of the invention.

FIG. 2 is a photograph taken with a scanning electron microscope of the powder obtained in Example 1a) of the invention.

FIG. 3 is an x-ray diffraction diagram for the powder obtained according to Example 1b) of the invention.

FIG. 4 is a photograph taken with a scanning electron microscope of the electrolyte layer obtained according to Example 2.

FIG. 5 is a photograph taken with a scanning electron microscope of the anode layer obtained after reduction according to Example 2.

FIG. 6 is another photograph taken with a scanning electron microscope of the anode layer obtained according to Example 2.

FIG. 7 is a photograph taken with a scanning electron microscope of the interface between the anode layer and the electrolyte layer obtained according to Example 2.

FIG. 8 is a graph illustrating the variation of conductivity σ (in S.cm⁻¹) versus (1000/T) (T being the temperature expressed in ° C.) of an anode material according to the invention.

FIG. 9 is a graph illustrating the variation of conductivity σ (in S.cm⁻¹) versus time t (in hours) of an anode material according to the invention placed at a temperature of 700° C.

### DETAILED DISCUSSION OF PARTICULAR EMBODIMENTS

The present examples and their use for elaborating an anode material for an SOFC cell (Example 2).

### EXAMPLE 1

The present example illustrates the preparation of a composite powder by a method according to the invention.

The preparation of this composite powder comprises:

the preparation of an apatite powder of formula La₉SrSi₆O_{26.5;}

the preparation of the composite powder from the apatite powder prepared beforehand.

a) Preparation of an Apatite Powder of Formula La₉SrSi₆O_{26.5}

The apatite powder of the aforementioned powder is synthesized by reaction in the solid state according to the following overall synthesis reaction:

4.5 La₂O₃+6 SiO₂+SrCO₃←La₉SrSi₆O_{26.5}+CO₂

Before putting into contact the precursors appearing in the reaction above, the strongly hygroscopic precursors La₂O₃ and SiO₂ are subject to heat treatment at 800° C. for 4 hours.

Immediately after this heat treatment, the precursors as powders are weighed so as to isolate the following respective masses:

Mass of La₂O_{3:} 113.93 g

Mass of SiO₂: 28.01 g

Mass of SrCO_{3:} 11.47 g

The thereby weighed powders are mechanically homogenized in an attrition jar in the presence of spherical zirconia balls and of osmosed water. Attrition is conducted until an average diameter of the grains centered on 1 μm is attained, so as to ensure sufficient reactivity of the precursors during the subsequent calcination.

The suspension is then separated from the attrition balls by sifting and the solvant is rapidly evaporated in a ventilated oven in order to preserve the homogeneity of the mixture.

The attrited mixture of precursors is then calcined at 1,400° C. for 4 hours so as to form the apatite phase. No secondary phase containing the strontium element was detected by x-ray diffraction confirming the incorporation of Sr²⁺ into the apatite lattice.

After calcination, the powder is agglomerated. Its density measured by pycnometry with helium is evaluated to be 5.44.

Milling by attrition of the calcined powder in ethanol in the presence of a dispersant (a phosphoric ester of the Beycostat CP 213 type) was carried out followed by a debinding step for removing the dispersant at 500° C. for 2 hours with a rise in temperature of 0.3° C./min.

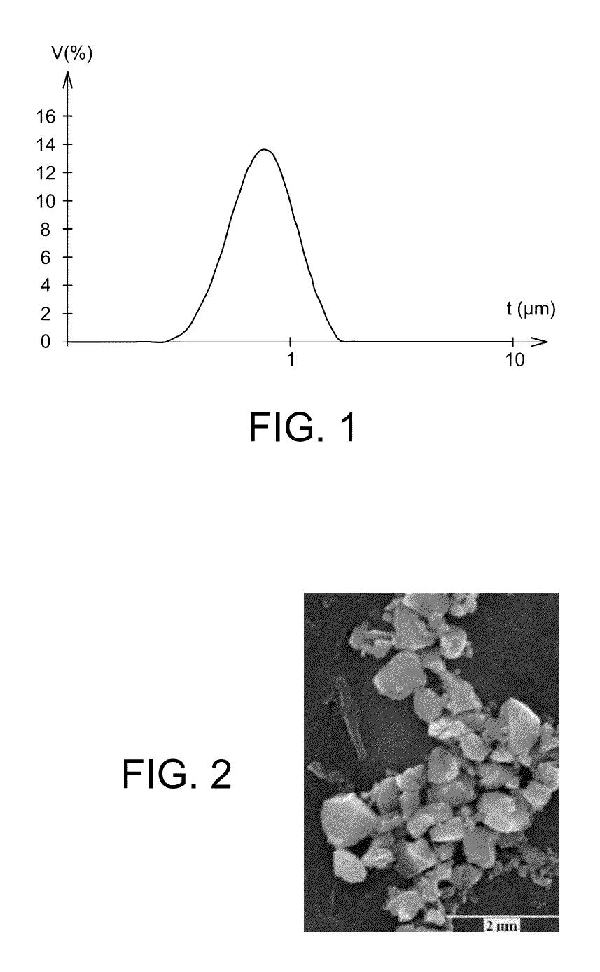

An apatite powder is thereby obtained, which has a single-mode grain size centered on 0.75 μm and equiaxed grains, as illustrated in FIGS. 1 and 2, which respectively illustrate:

a graph representing the grain size distribution of the obtained powders, and more particularly the variation of the particle size t (in μm) versus the obtained powder volume V (in %), showing centering of the grain size on 0.75 μm;

a photograph taken with a scanning electron microscope of this same powder.

The specific surface area of the powder is close to 5 m²/g.

The obtained amount of powder is 150 g.

b) Preparation of the Composite Powder Comprising 40% by Volume of Nickel

In a first phase, 20 g of the apatite powder prepared according to the procedure described above is suspended in 150 mL of osmosed water. Deagglomeration and dispersion of the powder is carried out with ultrasonic waves for 5 minutes. The suspension has a pH of 9.4 and its zero load point as determined by acoustophorometry is 8.5.

In a second phase, 77.10 g of a nickel salt (nickel acetate tetrahydrate Ni(CH₃COO)₂.4H₂O)) are solubilized with mechanical stirring in 600 mL of osmosed water. The volume percentage of nickel was set to 40% by volume based on the apatite powder (the volume percentage corresponds to the ratio of the nickel volume over the sum of the volume of nickel and of the volume of apatite). The pH of the obtained solution is 6.

In a third phase, 600 mL of the aqueous solution is added to the totality of the apatite suspension obtained beforehand. This addition shifts the pH of the mixture to a value of 6.3 and the zeta potential measured by acoustophorometry is 35 mV. In order to avoid agglomeration of apatite particles, a basic solution of ammonium hydroxide (NH₄OH, 0.2 mol/L) is added up to a pH of 9, by means of which a stable apatite suspension is obtained in the solution of nickel acetate, the zeta potential of the resulting mixture being 52 mV.

The solvant is then evaporated with magnetic stirring.

The recovered powder is calcined in air at 1,000° C. for 2 hours. With this temperature, it is possible to totally decompose the nickel acetate into nickel oxide, NiO and to promote adhesion of these particles at the surface of the apatite particles.

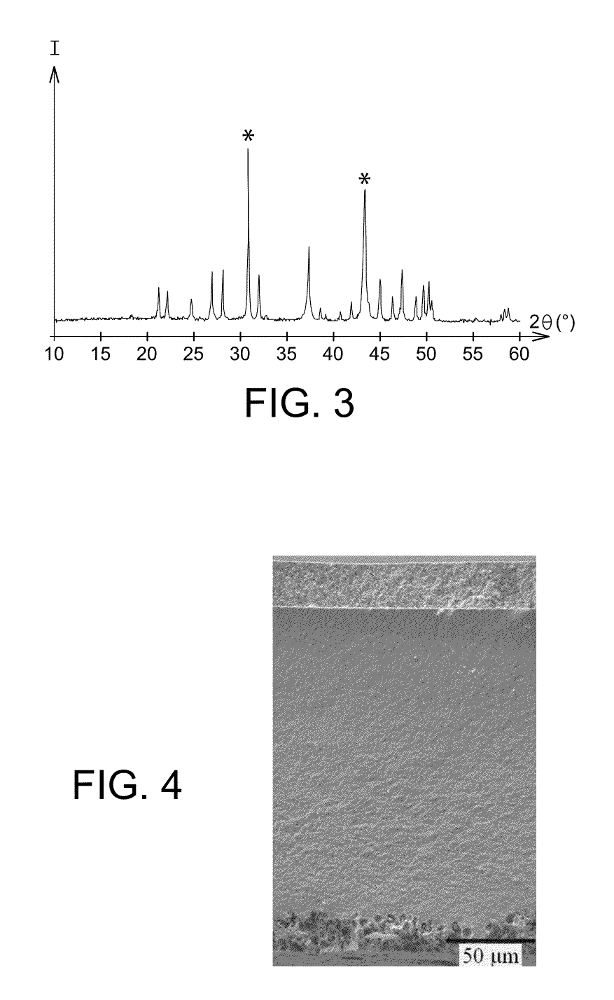

The x-ray diffraction diagram made of the synthesized powder shows the peaks of the apatite as well as the wide peaks corresponding to NiO, as confirmed by FIG. 3 illustrating an x-ray diffraction diagram of the obtained powder, the peaks indicated with an asterisk indicating the presence of NiO.

The density of the synthesized powder is evaluated to be 6 by pycnometry with helium and its specific surface area is 12.6 m²/g for an apatite powder having an average particle size of 0.75 μm.

The covering of the apatite particles with nickel oxide NiO is homogeneous and the size of the NiO crystallites varies from 50 to 100 nm.

### COMPARATIVE EXAMPLE

The present example illustrates the preparation of a composite powder with a method not compliant with the invention.

The preparation of this composite powder comprises:

the preparation of an apatite powder of formula La₉SrSi₆O_{26.5;}

the preparation of the composite powder from the apatite powder prepared beforehand.

a) Preparation of an Apatite Powder of Formula La₉SrSi₆O_{26.5}

This powder is prepared according to Example 1.

b) Preparation of the Composite Powder Comprising 30% by Volume of Nickel

In a first phase, 20 g of the apatite powder prepared according to the procedure described above are suspended in 50 mL of absolute ethanol with 0.3 g of CP 213 dispersant (i.e. 1.5% by mass based on the powder). Deagglomeration and dispersion of the powder are carried out with ultrasonic waves for 3 minutes.

In a second phase, 71 g of nickel nitrate are solubilized with mechanical stirring, in 200 mL of absolute ethanol.

Both solutions are then mixed on a roller mill for 48 hours before evaporating the solvant on a heating plate at 70° C., with magnetic stirring.

The resulting mixture is calcined in air at 500° C. for 2 hours (rates of 2° C./min for the ramps), so as to decompose the nitrates and ensure adhesion of the nickel oxide particles to the surface of the apatite particles.

The x-ray diffraction diagram made on the calcined powder shows decomposition of the apatite powder into the nickel nitrate solution because of the appearance of an amorphous dome between 23 and 35°, which confirms the fact that the apatite powder does therefore not seem to be stable in a nickel nitrate solution.

### EXAMPLE 2

In this example, it is proceeded with the elaboration of a complete (anode/electrolyte/cathode) cell with a strip-casting method inherited from the manufacturing of multilayer structures consisting of a stack of ceramic sheets of different natures.

The starting materials are the following:

a ceramic powder with a perovskite structure of formula La_{0.8}Sr_{0.2}Mn_{0.8}Co_{0.2}O_{3-δ} with 0≦δ≦1, intended to form the cathode (subsequently called a cathode powder);

a ceramic powder of the apatite type of formula La₉SrSi₆O_{26.5} intended to form the electrolyte (subsequently called an electrolyte powder); and

a composite powder as prepared according to Example 1 (subsequently called an anode powder).

For each of the aforementioned powders, a suspension comprising said powder, an organic solvant, a dispersant, a binder and a plasticizer and additionally a porogenic compound for the ceramic powder with a perovskite structure, is prepared. The amounts and ingredients used for making these different suspensions appear in the tables below.

For the electrolyte powder suspension:

| Ingredients | Amount |
|---|---|
| Apatite powder | 100 g |
| Solvant: | 21.3 g |
| Methylethylketone/ethanol 40%:60% by volume | |
| Dispersant agent Beycostat CP 213 | 1.4 g |
| Methacrylic resin binding agent | 7.7 g |
| Dibutylphthalate plasticizing agent | 8.5 g |

For the cathode powder suspension:

| Ingredients | Amount |
|---|---|
| Powder | 100 g |
| Solvant: | 27.5 g |
| Methylethylketone/ethanol 40%:60% by volume | |
| Dispersant Agent Beycostat CP 213 | 1.0 g |
| Methacrylic resin binding agent | 6.5 g |
| Dibutylphthalate plasticizing agent | 7.8 g |
| Maize starch porogenic agent | 25 g |

For the anode powder suspension:

| Ingredients | Amount |
|---|---|
| Powder | 100 g |
| Solvant: | 36 g |
| Methylethylketone/ethanol 40%:60% by volume | |
| Dispersant agent Beycostat CP 213 | 5.1 g |
| Methacrylic resin binding agent | 5.7 g |
| Dibutylphthalate plasticizing agent | 6.9 g |

The general procedure for preparing these suspensions is the following:

a) Deagglomerating and dispersing by means of a planetary gear milling machine for 1 hour at 270 rpm, a mixture formed with the powder, the solvant and the dispersant;

b) Adding the binding agent, the plasticizing agent and if necessary the porogenic agent;

c) Homogenization with the planetary gear milling machine for 16 hours at 120 rpm;

d) Deaeration of the resulting slurry in the rotating jar for a duration from 24 to 48 hours at a very slow speed of rotation.

For each of the aforementioned suspensions, it is proceeded with the deposition on a support of an amount of the latter by means of a knife (this method being called <<doctor-blade method>>).

Evaporation of the organic solvant leads to a raw strip having mechanical cohesion and flexibility allowing it to be handled.

For each of the raw strips obtained from the aforementioned suspensions, it is proceeded with the punching of the latter as tablets by means of a punch with a diameter of 30 mm.

Three tablets, from a raw strip stemming from the cathode powder, from a raw strip stemming from the electrolyte powder and from a raw strip stemming from the anode powder, respectively, are stacked and then thermocompressed.

The raw strips stemming from the electrode powders (cathode and anode) have a thickness of 100 μm and the raw strip stemming from the electrolyte powder has a thickness of 250 μm.

The stack resulting from the three raw strips is then subject to debinding so as to remove the organic compounds introduced into the aforementioned suspensions, and is then sintered in air at 1,400° C. for 2 hours.

The thickness of the electrolyte is 175 μm, as confirmed by FIG. 4. The thickness of the cathode and of the anode is 23 and 24.5 μm respectively.

Significant reduction in the thickness of the materials after sintering is partly due to the shrinkage experienced by these materials during sintering (16-17%) but also to significant creep caused by thermocompression, causing a reduction in the thickness of the raw materials.

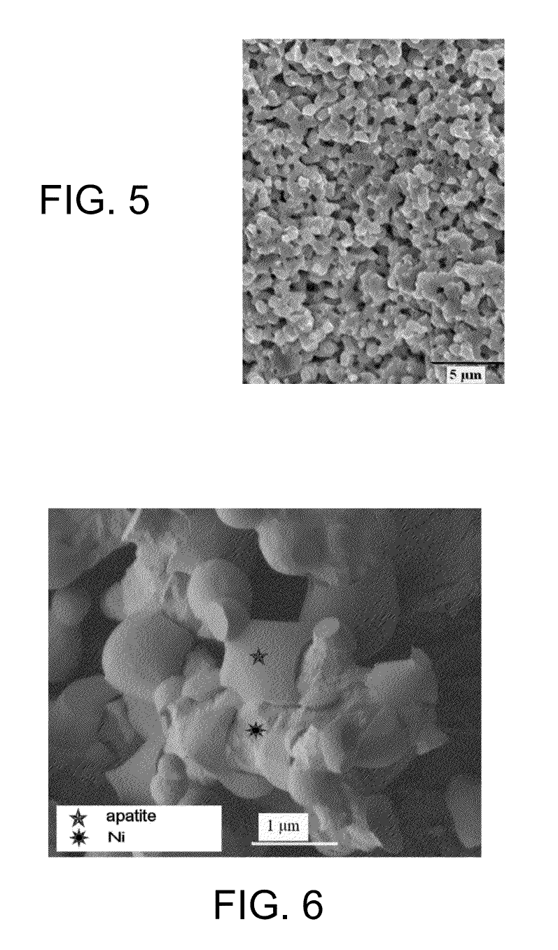

The electrolyte is dense. The porosity of the cathode of the order of 40% is well interconnected and open with a pore diameter of about 10 μm. Reduction of nickel oxide under hydrogenated argon at 700° C. (including 3% by volume of hydrogen) leads to an anode, for which the porosity is of the order of 40%. A photograph with a scanning electron microscope of this anode after reduction is illustrated in FIG. 5.

The covering of the apatite particles with nickel is homogeneous and paths for electron percolation by the nickel particles and ion percolation by the apatite particles are visible on the photograph with a scanning electron microscope of this anode, illustrated in FIG. 6.

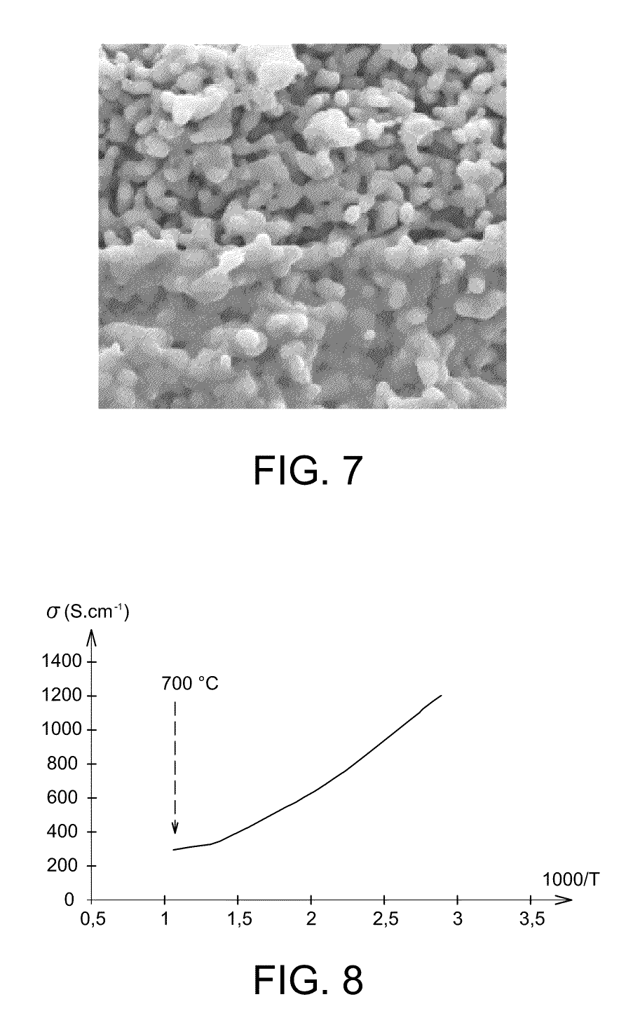

No delamination was observed at the interface between the electrolyte and the electrodes, as confirmed by the photographs taken with a scanning electron microscope of the interface illustrated in FIG. 7, which shows very good chemical adhesion between the electrolyte material and the electrode materials. Moreover, this adhesion does not generate any interdiffusion of the chemical elements from one layer to the other.

The conductivity of the anode was measured at different temperatures, the values of conductivity are transferred to FIG. 8 illustrating a graph depicting the variation of conductivity σ (in S.cm⁻¹) versus (1,000/T), T being the temperature in ° C.

The result is clearly high conductivity, and notably a conductivity of more than 100 S/cm at 700° C. (more particularly equal to about 290 S/cm).

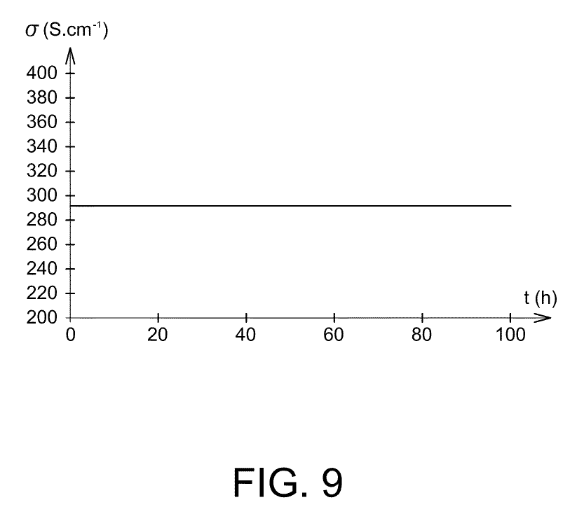

The anode material also has increased lifetime, which might be ascribed to the absence of agglomeration of the metal particles covering the apatite. In order to confirm this effect, it was notably proceeded with measurement of conductivity versus time at a temperature of 700° C. The measurement results have been transferred to the graph of FIG. 9 illustrating the variation of the conductivity σ (in S.cm⁻¹) versus time t (in h) at 700° C. The curve is a horizontal line, which confirms the stability of the material.

1. A method for preparing a composite powder comprising a core comprising an apatite and a coating layer covering all or part of said core, said coating layer comprises particles in a metal element and/or in an oxide thereof, which method successively comprises the following steps:
a) a step for putting a suspension of an apatite powder in a liquid medium into contact with a salt of a metal element, which is an acetate of a metal element;
b) a step for evaporating the solvant making up the liquid medium; and
c) a step for calcination of the powder resulting from step b) in an oxidizing atmosphere, by means of which a composite powder is obtained comprising an apatite core and a coating layer comprising particles of metal oxides; and
d) optionally, a step for total or partial reduction of said metal oxide particles into metal particles.

2. The method according to claim 1, wherein the apatite belongs to the family of lanthanide silicates.

3. The method according to claim 1, wherein the apatite fits the following formula:
A₁₀₋ₓDₓ(MO₄)₆O_{2±δ}
wherein:
A is a lanthanide element;
D is an element selected from alkaline elements, earth alkaline elements and mixtures thereof;
M is an element selected from silicon, germanium, aluminum, magnesium, gallium, boron, zinc, niobium and mixtures thereof;
O is the oxygen element;
x is a number such that 0≦x≦2;
δ is a number such that 0≦δ≦1.

4. The method according to claim 3, wherein the apatite fits the following formula:
La₁₀₋ₓDₓ(Si_{1-y}E_{y}O₄)₆O_{2±δ}
wherein:
D is an element selected from alkaline elements, earth alkaline elements and mixtures thereof;
E is an element selected from germanium, aluminum, magnesium, gallium, boron, zinc, niobium and mixtures thereof;
x is a number such that 0≦x≦2;
y is a number such that 0≦y≦1;
δ is a number such that 0≦δ≦1.

5. The method according to claim 1, wherein the apatite fits the formula La₉SrSi₆O_{26.5}.

6. The method according to claim 1, wherein the metal element is an element belonging to the group of transition metals.

7. The method according to claim 1, wherein the metal element is selected from Ru, W, Rh, Ir, Ni, Cu, Pt, Fe, Mo, Pd and mixtures thereof.

8. The method according to claim 1, wherein the metal element is nickel.

9. The method according to claim 1, wherein the metal oxide is an oxide of a metal element belonging to the group of transition metals.

10. The method according to claim 1, wherein the particles making up the coating layer have a nanometric average grain size (i.e. an average grain diameter).

11. The method according to claim 1, wherein the metal oxide is an oxide of a metal element selected from Ru, W, Rh, Ir, Ni, Cu, Pt, Fe, Mo, Pd and mixtures thereof.

12. The method according to claim 1, wherein the metal oxide is an oxide of nickel.
